(19) United States
(12) Patent Application Publication
(10) Pub. No.: US 2025/0013197 A1
(43) Pub. Date: Jan. 9, 2025

(54) HOLOGRAPHIC RECORDING MEDIUM, COMPOSITION FOR FORMING PHOTOPOLYMER LAYER AND OPTICAL ELEMENT

(71) Applicant: LG CHEM, LTD., Seoul (KR)

(72) Inventors: Yeonhui YI, Daejeon (KR); Hanna LEE, Daejeon (KR); Min Soo KIM, Daejeon (KR); Inkyu LEE, Daejeon (KR); Chulsuk HONG, Daejeon (KR); Soonhwa JUNG, Daejeon (KR)

(73) Assignee: LG CHEM, LTD., Seoul (KR)

(21) Appl. No.: 18/710,498

(22) PCT Filed: Oct. 17, 2023
(86) PCT No.: PCT/KR2023/016083

§ 371 Date: May 15, 2024

(30) Foreign Application Priority Data
Oct. 18, 2022 (KR) 10-2022-0134345
Oct. 16, 2023 (KR) 10-2023-0138056

(51) Int. Cl. G03H 1/02; C08K 13/00; C08L 83/04; G03H 1/04; G11B 7/24; G11B 7/24067

(52) U.S. Cl. CPC G03H 1/0256; C08K 13/00; C08L 83/04; G03H 1/0402; G11B 7/24067; G11B 2007/240025

(57) ABSTRACT

The present invention relates to a holographic recording media wherein an adhesive force between the photopolymer layer and the adhesive protective layer before light irradiation is 500 to 5,000 gf/20 nm, and a haze value of the photopolymer layer is 3% or less, and an optical element including the holographic recording medium.

### CROSS-REFERENCE TO RELATED APPLICATION(S)

This application is a 35 U.S.C. § 371 National Phase Entry Application from PCT/KR2023/016083, filed on Oct. 17, 2023, which claims the benefit of Korean Patent Application No. 10-2022-0134345 filed on Oct. 18, 2022 and Korean Patent Application No. 10-2023-0138056 filed on Oct. 16, 2023 in the Korean Intellectual Property Office, the disclosures of which are incorporated herein by reference in their entirety.

### TECHNICAL FIELD

The present invention relates to a holographic recording medium, a composition for forming a photopolymer layer and an optical element.

### BACKGROUND

Holographic recording medium records information by changing a refractive index in the holographic recording layer in the medium through an exposure process, reads the variation of refractive index in the medium thus recorded, and reproduces the information.

In this regard, a photopolymer composition can be used for preparing a hologram. The photopolymer can easily store light interference pattern as a hologram by photopolymerization of a photoreactive monomer. Therefore, the photopolymer can be used in various fields such as, for example, smart devices such as mobile devices, wearable display parts, vehicle articles (e.g., head up display), holographic fingerprint recognition system, optical lenses, mirrors, deflecting mirrors, filters, diffusing screens, diffraction elements, light guides, waveguides, holographic optical elements having projection screen and/or mask functions, medium of optical memory system and light diffusion plate, optical wavelength multiplexers, reflection type, transmission type color filters, and the like.

Specifically, a photopolymer composition for hologram production includes a polymer matrix, a photoreactive monomer, and a photoinitiator system, and the photopolymer film prepared from such a composition is irradiated with laser interference light to induce photopolymerization of local monomers.

A refractive index modulation is generated through this local photopolymerization process, and a diffraction grating is generated by such a refractive index modulation. The refractive index modulation value (Δn) is influenced by the thickness and the diffraction efficiency (DE) of the photopolymer film, and the angular selectivity increases as the thickness decreases.

Recently, development of materials capable of maintaining a stable hologram with a high diffraction efficiency has been demanded, and also various attempts have been made to produce a photopolymer film having high diffraction efficiency and high refractive index modulation values as well as a thin thickness.

On the other hand, when a holographic recording medium is used as an optical element in applications such as mobile devices or vehicle articles (e.g., head-up display), it is placed in a high temperature/high humidity environment.

Moreover, a film in which a diffraction grating is generated in a holographic recording medium can be applied to actual products only when it is excellent in reliability such as heat resistance and moisture resistance, and in this case, reliability mainly depends on matrix characteristics.

However, the holographic recording media currently used has a problem that the adhesive force is not exhibited at a desired level in a high temperature/high humidity environment, which causes a problem that reliability decreases.

Therefore, there is a need to develop a photopolymer film and a holographic recording media including the same that are excellent in both recording efficiency and reliability even in various surrounding use environments.

### DETAILED DESCRIPTION OF THE INVENTION

### Technical Problem

It is an object of the present invention to provide of a holographic recording medium comprising a photopolymer layer having high recording efficiency and diffraction efficiency, as well as excellent adhesive force and low haze characteristics.

It is another object of the present invention to provide a composition for forming a photopolymer layer that can realize a higher refractive index modulation value even in a thin thickness range by using an adhesive additive, and also can efficiently provide a photopolymer layer of the holographic recording medium, which is improved in adhesion characteristics and thus has more excellent reliability than in conventional ones.

It is yet another object of the present invention to provide an optical element comprising the holographic recording medium.

### Technical Solution

Provided herein is a holographic recording media comprising a substrate; an adhesive protective layer; and a photopolymer layer, wherein an adhesive force between the photopolymer layer and the adhesive protective layer before light irradiation is 500 to 5,000 gf/20 nm, and wherein a haze value of the photopolymer layer measured in accordance with JIS K7136:2000 is 3% or less.

Also provided herein is an optical element comprising the holographic recording medium.

Further provided herein is a photopolymer composition for hologram formation comprising a polymer matrix or a precursor thereof; a photoreactive monomer including a monofunctional monomer and a polyfunctional monomer; an adhesive additive; and a photoinitiator, wherein the ratio of the monofunctional monomer among the photoreactive monomers is more than 40% by weight and 70% by weight or less.

Hereinafter, a holographic recording medium, a photopolymer composition for hologram formation included in the holographic recording medium, a preparation method thereof, an optical element comprising the same, and the like according to specific embodiments of the present invention will be described.

As used herein, the (meth)acrylate refers to either methacrylate or acrylate.

As used herein, the (co)polymer refers to either a homopolymer or a copolymer (including a random copolymer, a block copolymer, and a graft copolymer).

The term “hologram” as used herein refers to a recording medium in which optical information is recorded in an entire visible range and a near ultraviolet range (e.g., 300 to 800 nm) through an exposure process, and examples thereof include all of visual holograms such as in-line (Gabor) holograms, off-axis holograms, full-aperture transfer holograms, white light transmission holograms (“rainbow holograms”), Denisyuk holograms, off-axis reflection holograms, edge-lit holograms or holographic stereograms.

As used herein, the alkyl group may be straight-chain or branched-chain, and the carbon number thereof is not particularly limited, but is preferably 1 to 40. According to one embodiment, the carbon number of the alkyl group is 1 to 20. According to another embodiment, the carbon number of the alkyl group is 1 to 10. According to another embodiment, the carbon number of the alkyl group is 1 to 6. Specific examples of the alkyl group include methyl, ethyl, propyl, n-propyl, isopropyl, butyl, n-butyl, isobutyl, tert-butyl, sec-butyl, 1-methyl-butyl, 1-ethyl-butyl, pentyl, n-pentyl, isopentyl, neopentyl, tert-pentyl, hexyl, n-hexyl, 1-methylpentyl, 2-methylpentyl, 4-methyl-2-pentyl, 3,3-dimethylbutyl, 2-ethylbutyl, heptyl, n-heptyl, 1-methylhexyl, cyclopentylmethyl, cyclohexylmethyl, octyl, n-octyl, tert-octyl, 1-methylheptyl, 2-ethylhexyl, 2-propylpentyl, n-nonyl, 2,2-dimethylheptyl, 1-ethyl-propyl, 1,1-dimethyl-propyl, isohexyl, 4-methylhexyl, 5-methylhexyl, and the like, but are not limited thereto.

In this specification, the alkylene group is a bivalent functional group derived from alkane, and may be, for example, straight-chain, branched-chain or cyclic methylene group, ethylene group, propylene group, isobutylene group, sec-butylene group, tert-butylene group, pentylene group, hexylene group, and the like.

In this specification, the term “substituted or unsubstituted” means being unsubstituted or substituted with one or more substituent groups selected from the group consisting of deuterium; a halogen group; a cyano group; a nitro group; a hydroxy group; a carbonyl group; an ester group; an imide group; an amino group; a primary amino group; a carboxyl group; a sulfonic acid group; a sulfonamide group; a phosphine oxide group; an alkoxy group; an aryloxy group; an alkylthioxy group; an arylthioxy group; an alkylsulfoxy group; an arylsulfoxy group; a silyl group; a boron group; an alkyl group; a haloalkyl group; a cycloalkyl group; an alkenyl group; an aryl group; an aralkyl group; an aralkenyl group; an alkylaryl group; an alkoxysilylalkyl group; an arylphosphine group; or a heterocyclic group containing at least one of N, O and S atoms, or being unsubstituted or substituted with a substituent group to which two or more substituent groups of the above-exemplified substituent groups are linked. For example, “a substituent group in which two or more substituents are linked” may be a biphenylyl group. Namely, a biphenylyl group may be an aryl group, or it may be interpreted as a substituent group in which two phenyl groups are linked. Preferably, a halogen group may be used as the substituent, and examples of the halogen group include a fluoro group.

The term “hologram” as used herein refers to a recording medium in which optical information is recorded in an entire visible range and an ultraviolet range (e.g., 300 to 1,200 nm) through an exposure process, unless specifically stated otherwise. For example, the hologram herein may include all of visual holograms such as in-line (Gabor) holograms, off-axis holograms, full-aperture transfer holograms, white light transmission holograms (“rainbow holograms”), Denisyuk holograms, off-axis reflection holograms, edge-lit holograms or holographic stereograms.

Further, in the present invention, the holographic recording medium may include a photopolymer film.

Further, as used herein, the weight average molecular weight (Mw) and the number average molecular weight (Mn) refers to the molecular weight converted in terms of polystyrene (unit: Da (Dalton)) measured by gel permeation chromatography (GPC). In the process of determining the weight average molecular weight in terms of polystyrene measured by the GPC method, a detector such as a commonly known analysis apparatus and differential refractive index detector, and an analytical column can be used, and commonly applied conditions for temperature, solvent, and flow rate can be used. Specific examples of the measurement conditions may include a temperature of 30° C., chloroform solvent and a flow rate of 1 mL/min. In specific examples of the measurement conditions, a Waters PL-GPC220 instrument was used with a PLgel MIX-B column (length of 300 mm) from Polymer Laboratories, the evaluation temperature was 160° C., 1,2,4-trichlorobenzene was used as a solvent, and the flow rate was 1 mL/min. The sample was prepared at a concentration of 10 mg/10 mL, and then supplied in an amount of 200 μL. The values of Mw and Mn can be respectively determined using the calibration curve generated with polystyrene standards. Nine types of the polystyrene standards with respective molecular weights of 2,000/10,000/30,000/70,000/200,000/700,000/2,000,000/4,000,000/10,000,000 were used.

According to one embodiment of the invention, there is provided a holographic recording media comprising a substrate; an adhesive protective layer; and a photopolymer layer, wherein an adhesive force between the photopolymer layer and the adhesive protective layer before light irradiation is 500 to 5,000 gf/20 nm, and wherein a haze value of the photopolymer layer measured in accordance with JIS K7136:2000 is 3% or less.

The present inventors have found through experiments that in addition to the matrix of the holographic recording medium and the recording monomer, a specific adhesive additive is further used in the photopolymer composition for forming the photopolymer layer contained in the holographic recording medium, whereby an adhesive force between the photopolymer layer and the adhesive protective layer of the holographic recording medium is improved compared to the conventional one, which can realize excellent reliability, the diffraction efficiency and high refractive index modulation values can be realized even with a thin thickness, and excellent reliability can be realized even under high temperature/high humidity conditions, and completed the present invention.

The adhesive additive serves to improve an adhesive force between the photopolymer layer and the adhesive protective layer formed on the substrate after forming the photopolymer layer using the photopolymer composition, and also exhibit a specific water contact angle.

Further, the adhesive additive may play a role of ensuring that the surface of the photopolymer layer not only is formed uniformly but also has low haze characteristics, and thus preventing the surface from becoming sticky.

More specifically, the haze value of the photopolymer layer measured in accordance with JIS K7136:2000 may be 3% or less, or 2.5% or less, or 2.0% or less, or 0.1% or more, or 0.5% or more. As the photopolymer layer has a haze value of 3% or less, it can have excellent optical characteristics and high transmittance, and can prevent a phenomenon in which the refractive index modulation value and the diffraction index of the holographic recording medium decrease.

The haze value of the photopolymer layer may be a value measured before or after recording on the holographic recording medium.

In other words, the use of the above additive can improve the coating properties of the composition for forming a photopolymer layer, and exhibit a difference in adhesive force between the photopolymer layer and the adhesive protective layer compared to the conventional one, thereby providing a hologram medium having excellent reliability.

Therefore, a holographic recording medium using a photopolymer composition containing the above adhesive additive can maintain excellent optical characteristics, and when a holographic recording medium (photopolymer film) is attached to or detached from the other medium, attachment or detachment can be made easy.

Further, the photopolymer composition uses a mixture of a monofunctional monomer and a polyfunctional monomer as a photoreactive monomer, and the ratio of monofunctional monomers in the total content of the photoreactive monomers is adjusted to a specific ratio, thereby further improving the adhesive force between the adhesive protective layer and the photopolymer layer.

The holographic recording medium of one embodiment can be provided by sequentially forming an adhesive protective layer and a photopolymer layer on a substrate.

In this holographic recording medium, the adhesive force between the photopolymer layer and the adhesive protective layer before light irradiation may be 500 to 5,000 gf/20 nm.

Specifically, the photopolymer layer includes a crosslinked type polymer matrix or a precursor thereof, an adhesive additive, and a cured product of photoreactive monomers including a monofunctional monomer and a polyfunctional monomer in which the content of the monofunctional monomer is adjusted, so that the adhesive force between the adhesive protective layer and the photopolymer layer can be improved compared to conventional ones.

Further, in a holographic recording medium, the water contact angle of the photopolymer layer after light irradiation may be 50 to 100°.

Further, when the adhesive protective layer and the mold release film are peeled off, the water contact angle reduction rate of the photopolymer layer after light irradiation may decrease at a rate of 5 to 15°/min.

By realizing the adhesive force and the water contact angle, the water contact angle reduction rate can be adjusted so as to be lowered to the above range even after light irradiation, and thus the adhesive force can be improved compared to the conventional one. In other words, a film having a low water contact angle exhibits the tendency to increase in adhesive force. However, when the photopolymer composition of the one embodiment is used, the adhesive force with the adhesive protective layer formed on the substrate after forming the photopolymer layer is improved, and a holographic recording medium having a low water contact angle can be provided.

At this time, the adhesive force can be evaluated by performing a 180° Peel Test using an adhesive force measuring device (Texture Analyzer) and measuring the load applied to a width of 25 mm.

After 2 μl of H₂O is dropped onto the photopolymer layer exposed to a red light source of a certain wavelength, the water contact angle (surface contact angle) of the photopolymer layer can be measured using a drop shape analyzer.

In the holographic recording medium of the one embodiment, respective components will be specifically described.

The type of the substrate is not particularly limited, and those known in the related technical field can be used. For example, a cellulose ester-based base film, a polyester-based base film, a poly(meth)acrylate-based base film, a polycarbonate-based base film, a cycloolefin-based (COP) base film, a glass, an acrylic base film, and the like may be used. Specifically, substrate such as PET(polyethylene terephthalate), TAC(triacetyl cellulose), PC(polycarbonate), COP(cycloolefin polymer), and polymethyl methacrylate (PMMA) may be used.

The thickness of the substrate is not particularly limited and, for example, it may have a thickness of 1 to 1,000 μm.

The adhesive protective layer can be used as a protective film for the photopolymer layer, and may include a barrier pressure-sensitive adhesive (BPSA) for level difference absorption at a thickness level that has a level difference absorbing property on one side of the substrate.

The adhesive protective layer may include a typical photocurable pressure-sensitive adhesive, but the type thereof is not limited. For example, the pressure-sensitive adhesive may be at least one selected from the group consisting of an acrylic-based adhesive, a silicone-based adhesive, a urethane-based adhesive and a rubber-based adhesive. Specifically, the pressure-sensitive adhesive layer includes (meth)acrylate-based resin; and a polymer containing at least one selected from the group consisting of polysiloxane.

The thickness of the adhesive protective layer may be 10 to 100 μm, but is not limited thereto.

The photopolymer layer may be formed by laminating one or more layers on an adhesive protective layer, and specifically, the photopolymer layer may be laminated in two or more layers on the adhesive protection layer.

The photopolymer layer includes a photopolymer composition that comprises a polymer matrix or a precursor thereof; a photoreactive monomer including a monofunctional monomer and a polyfunctional monomer; an adhesive additive; and a photoinitiator, wherein the ratio of the monofunctional monomer among the photoreactive monomers may be more than 40% by weight and 70% by weight or less, 42 to 68% by weight, or 45 to 65% by weight.

The adhesive additive includes a polydimethylsiloxane-based additive.

By including a polydimethylsiloxane-based additive, it is possible to improve the adhesive force between the photopolymer layer and the adhesive protective layer formed on the substrate after the photopolymer layer is formed, exhibit a specific water contact angle and impart hydrophilicity.

The polydimethylsiloxane-based additive has a weight average molecular weight of 100 to 10000, and may include at least one selected from a polyether-modified polydimethylsiloxane, a polymethylalkylsiloxane silicone surfactant and an organic-modified silicone. Specifically, the polydimethylsiloxane-based additive may include a polyether-modified polydimethylsiloxane; or a silicone and polyether macromer modified polyacrylate.

Further, the adhesive additive may be contained in an amount of 0.001 to 0.1 parts by weight based on 100 parts by weight of the polymer matrix or the precursor thereof. If the content of the adhesive additive does not meet the above range and is too low or too high, attachment or detachment may not be made easy when a photopolymer film is attached to or detached from the other medium.

The photopolymer composition may further include a non-reactive fluorinated compound. The non-reactive fluorinated compound can be used as a plasticizer.

Specifically, the non-reactive fluorinated compound may include at least one functional group selected from the group consisting of an ether group, an ester group, and an amide group, and at least two difluoromethylene groups.

More specifically, the non-reactive fluorinated compound may include a compound represented by the following Chemical Formula 3.

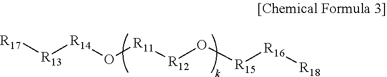

wherein, in Chemical Formula 3,
R₁₁ and R₁₂ are each independently a difluoromethylene group,
R₁₃ and R₁₆ are each independently a methylene group,
R₁₄ and R₁₅ are each independently a difluoromethylene group,
k is an integer of 1 to 10, and
R₁₇ and R₁₈ are each independently a straight-chain or branched-chain alkyl group having 1 to 10 carbon atoms or a functional group of the following Chemical Formula 4,

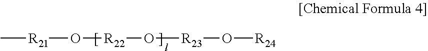

wherein, in Chemical Formula 4,
R₂₁, R₂₂ and R₂₃ are each independently a straight-chain or branched-chain alkylene group having 1 to 10 carbon atoms,
R₂₄ is a straight-chain or branched-chain alkyl group having 1 to 10 carbon atoms, and
l is an integer of 1 to 30.

More specifically, in Chemical Formula 3, R₁₁ and R₁₂ are each independently a difluoromethylene group, R₁₃ and R₁₆ are each independently a methylene group, R₁₄ and R₁₅ are each independently a difluoromethylene group, R₁₇ and R₁₈ are each independently a 2-methoxyethoxymethoxy group, and k is an integer of 2.

As the fluorinated compound, one having a lower refractive index than the photoreactive monomer can be used. In this case, the refractive index of the polymer matrix can be lowered and the refractive index modulation can be made larger.

The fluorinated compound may have a low refractive index of 1.45 or less. Specifically, the upper limit of the refractive index of the fluorinated compound may be, for example, 1.44 or less, 1.43 or less, 1.42 or less, 1.41 or less, 1.40 or less, 1.39 or less, 1.38 or less, or 1.37 or less, and the lower limit of the refractive index may be, for example, 1.30 or more, 1.31 or more, 1.32 or more, 1.33 or more, 1.34 or more, or 1.35 or more. Since a fluorinated compound having a lower refractive index than the above-mentioned photoreactive monomer is used, the refractive index of the polymer matrix can be further lowered, and the refractive index modulation with the photoreactive monomer can be made larger.

The fluorinated compound may be contained in the range of 20 to 75 parts by weight based on 100 parts by weight of the polymer matrix or the precursor thereof. Specifically, the lower limit of the content of the fluorinated compound may be, for example, 25 parts by weight or more, 30 parts by weight or more, 35 parts by weight or more, 40 parts by weight or more, 45 parts by weight or more, 50 parts by weight or more, or 55 parts by weight or more, and the upper limit thereof may be, for example, 70 parts by weight or less, 65 parts by weight or less, 60 parts by weight or less, 55 parts by weight or less, or 50 parts by weight or less. If the above range is satisfied, it is advantageous for ensuring excellent optical recording characteristics. When the content of the fluorinated compound is less than the above range, the refractive index modulation value after recording may be lowered due to a lack of low refractive components. In addition, when the fluorinated compound content exceeds the above range, there may be a problem that haze increases due to compatibility issues between components contained in the photopolymer film, or some fluorinated compounds are eluted onto the surface of the coating layer.

The fluorinated compound may have a weight average molecular weight of 300 or more. Specifically, the lower limit of the weight average molecular weight of the fluorinated compound may be, for example, 350 or more, 400 or more, 450 or more, 500 or more, 550 or more, or 600 or more, and the upper limit thereof may be, for example, 1000 or less, 900 or less, 800 or less, 700 or less, 600 or less, or 500 or less. Considering refractive index modulation, compatibility with other components, elution problems of fluorinated compounds, and the like, it is preferable that the above weight average molecular weight range is satisfied. At this time, the weight average molecular weight means the weight average molecular weight converted in terms of polystyrene measured by the GPC method as described above.

The photopolymer layer may be irradiated by a red light source. The photopolymer layer may be laminated in a mixed form by red hologram exposure. When the photopolymer layer is irradiated with light by the red light source, it can be irradiated within the well-known red wavelength range of 600 to 700 nm, and as an example, it may be irradiated at a wavelength of 630 to 680 nm under an intensity of 0.3 to 3.0 mW.

Further, the photopolymer layer includes a crosslinked type matrix. For example, the photopolymer layer may include or be formed from a composition including at least a crosslinked type matrix or a precursor thereof. In an embodiment of the present invention, the photopolymer layer may include or be formed from a composition that includes a crosslinked type matrix or a precursor thereof, a photoreactive monomer, and a photoinitiator.

In this holographic recording medium, the photopolymer layer is a holographic recording layer and may have a thickness ranging from 5 to 50 μm. Specifically, the thickness of the photopolymer film may be, for example, 5 m or more, 10 μm or more, 15 μm or more, or 30 μm or more. And, the upper limit of the thickness may be, for example, 30 μm or less or 20 μm or less, specifically 15 μm or less, 12 μm or less, or 8 μm or less. The holographic recording medium of the present invention has excellent refractive index modulation, diffraction efficiency, and driving reliability even when it has a thin thickness within the above-mentioned range.

The holographic recording medium of another embodiment can realize a refractive index modulation value (Δn) of 0.020 or more, 0.021 or more, 0.022 or more, 0.023 or more, 0.024 or more, 0.025 or more, 0.026 or more, 0.027 or more, 0.028 or more, 0.029 or more, or 0.030 or more even if the photopolymer layer has a thin thickness of 5 to 30 μm. The upper limit of the refractive index modulation value is not particularly limited, but may be, for example, 0.035 or less.

According to another embodiment of the invention, the holographic recording medium may further include a mold release film between the photopolymer layer and the adhesive protective layer.

Therefore, the holographic recording medium may include a structure in which a substrate, an adhesive protective layer, a mold release film, and a photopolymer layer are sequentially laminated from the bottom.

FIG. 1 briefly shows the structure of a holographic recording medium according to an embodiment, which further includes a mold release film.

As shown in FIG. 1, the holographic recording medium may include a structure in which a two-layer photopolymer layers 1 and 2, a mold release film 3, an adhesive protective layer 4, and a substrate 5 are laminated.

The mold release film may be formed through an adhesive protective layer, and may be formed so as to intersect at partial ends of the entire size of the adhesive protective layer and to be spaced apart at a predetermined interval.

Specifically, the mold release film is a layer that is located between the adhesive protective layer and the photopolymer layer and functions as an indicator when peeling them off, and refers to a transparent layer that is attached to a portion of the end of one side of the adhesive protective layer.

According to one embodiment of the invention, the mold release film may be laminated at predetermined intervals so as to intersect within the range of 0.5 to 1 cm at the end of the adhesive protective layer.

Further, the mold release film may be a commercially available fluorine-treated mold release film or a silicone-treated mold release film, but the type thereof is not limited. Further, the thickness of the mold release film is not limited and can be used within a range well known in this field.

The total thickness of the holographic recording medium may be 40 to 100 μm.

The holographic recording medium can exhibit diffraction efficiency of 80% or more and haze characteristics of 3.0% or less even at a thin thickness.

On the other hand, according to another embodiment of the invention, there is provided a photopolymer composition for hologram formation comprising a polymer matrix or a precursor thereof; a photoreactive monomer including a monofunctional monomer and a polyfunctional monomer; an adhesive additive; and a photoinitiator, wherein the ratio of the monofunctional monomer among the photoreactive monomers is more than 40% by weight and 70% by weight or less, 42 to 68% by weight, or 45 to 65% by weight.

The photopolymer composition of one embodiment includes a polymer matrix or a precursor thereof that serves as a support for the photopolymer layer formed therefrom.

The polymer matrix is formed by crosslinking a siloxane-based polymer containing a silane functional group (Si—H) and a (meth)acrylic-based polyol. Specifically, the polymer matrix is formed by crosslinking (meth)acrylic-based polyol with a siloxane-based polymer containing a silane functional group. More specifically, the hydroxy group of the (meth)acrylic-based polyol can form a crosslink with the silane functional group of the siloxane-based polymer through a hydrosilylation reaction. The hydrosilylation reaction can proceed rapidly under a Pt-based catalyst even at room temperature (e.g., a temperature in the range of about 15 to 30° C. which is a temperature without heating or cooling). Therefore, the photopolymer composition according to one embodiment of the invention employs a polymer matrix that can be quickly crosslinked even at room temperature as a support, thereby being able to improve the preparation efficiency and productivity of the holographic recording medium.

The polymer matrix can enhance the mobility of components (e.g., photoreactive monomer or plasticizer, etc.) contained in the photopolymer layer due to the flexible main chain of the siloxane-based polymer. In addition, siloxane bonding having excellent heat resistance and moist heat resistance characteristics can facilitate ensuring reliability of the photopolymer layer in which optical information is recorded, and of the holographic recording medium including the same.

The polymer matrix may have a relatively low refractive index, which can thus serve to enhance the refractive index modulation of the photopolymer film. For example, the upper limit of the refractive index of the polymer matrix may be 1.53 or less, 1.52 or less, 1.51 or less, 1.50 or less, or 1.49 or less. And, the lower limit of the refractive index of the polymer matrix may be, for example, 1.41 or more, 1.42 or more, 1.43 or more, 1.44 or more, 1.45 or more, or 1.46 or more. As used herein, “refractive index” may be a value measured with an Abbe refractometer at 25° C.

The photopolymer layer may include the polymer matrix in crosslinked form as described above, or may include a precursor thereof. When the photopolymer composition includes a precursor of the polymer matrix, it may include a siloxane-based polymer, a (meth)acrylic-based polyol, and a Pt-based catalyst.

As a specific example, the siloxane-based polymer may include a repeating unit represented by the following Chemical Formula 1 and a terminal end group represented by the following Chemical Formula 2.

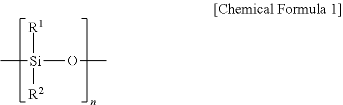

wherein, in Chemical Formula 1,
a plurality of R¹ and R² are the same or different from each other, and are each independently hydrogen, halogen, or an alkyl group having 1 to 10 carbon atoms, and
n is an integer of 1 to 10,000,

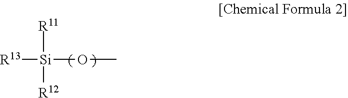

wherein, in Chemical Formula 2,
a plurality of R¹¹ to R¹³ are the same or different from each other, and are each independently hydrogen, halogen, or an alkyl group having 1 to 10 carbon atoms, and
at least one repeating unit of the repeating units represented by Chemical Formula 1 and at least one of R¹, R² and R¹¹ to R¹³ of any one terminal end among the terminal end groups represented by Chemical Formula 2, is hydrogen.

In Chemical Formula 2, —(O)— means either bonding through oxygen (O) or directly bonding without oxygen (O) when Si of the terminal end group represented by Chemical Formula 2 is bonded to the repeating unit represented by Chemical Formula 1.

As used herein, “alkyl group” may be a straight-chain, branched-chain, or cyclic alkyl group. By way of non-limiting example, “alkyl group” as used herein may be methyl, ethyl, propyl (e.g. n-propyl, isopropyl, etc.), butyl (e.g., n-butyl, isobutyl, tert-butyl, sec-butyl, cyclobutyl, etc.), pentyl (e.g., n-pentyl, isopentyl, neopentyl, tert-pentyl, 1,1-dimethyl-propyl, 1-ethyl-propyl, 1-methyl-butyl, cyclopentyl, etc.), hexyl (e.g., n-hexyl, 1-methylpentyl, 2-methylpentyl, 4-methylpentyl, 3,3-dimethylbutyl, 1-ethyl-butyl, 2-ethylbutyl, cyclopentylmethyl, cyclohexyl, etc.), heptyl (e.g., n-heptyl, 1-methylhexyl, 4-methylhexyl, 5-methylhexyl, cyclohexylmethyl, etc.), octyl (e.g., n-octyl, tert-octyl, 1-methylheptyl, 2-ethylhexyl, 2-propylpentyl, etc.), nonyl (e.g., n-nonyl, 2,2-dimethylheptyl, etc.), and the like.

In one example, R¹, R² and R¹¹ to R¹³ in Chemical Formulas 1 and 2 are methyl or hydrogen, and at least two of R¹, R² and R¹¹ to R¹³ may be hydrogen. More specifically, the siloxane-based polymer may be a compound in which R¹ and R² of Chemical Formula 1 are each independently methyl and hydrogen, and R¹¹ to R¹³ of Chemical Formula 2 are each independently methyl or hydrogen (e.g., polymethylhydrosiloxane whose terminal end group is a trimethylsilyl group or a dimethylhydrosilyl group); a compound in which some R¹ and R² of Chemical Formula 1 are methyl and hydrogen, respectively, both the remaining R¹ and R² are methyl, and R¹¹ to R¹³ of Chemical Formula 2 are each independently methyl or hydrogen (e.g., poly(dimethylsiloxane-co-methylhydrosiloxane) whose terminal end group is a trimethylsilyl group or a dimethylhydrosilyl group); or a compound in which both R¹ and R² of Chemical Formula 1 are methyl, at least one of R¹¹ to R¹³ of Chemical Formula 2 is hydrogen, and the remainder are each independently methyl or hydrogen (e.g., polydimethylsiloxane in which either or both of the terminal end groups are dimethylhydrosilyl groups).

The siloxane-based compound may have a number average molecular weight (Mn) in the range of 200 to 4,000 as an example. Specifically, the lower limit of the number average molecular weight of the siloxane-based polymer may be, for example, 200 or more, 250 or more, 300 or more, or 350 or more, and the upper limit thereof may be, for example, 3,500 or less, 3,000 or less, 2,500 or less, 2,000 or less, 1,500 or less, or 1,000 or less. When the number average molecular weight of the siloxane-based polymer satisfies the above range, it is possible to prevent the problems that during the crosslinking process with (meth)acrylic-based polyol which is performed at room temperature or higher, the siloxane-based polymer volatilizes and the degree of matrix crosslinking decreases, or the siloxane-based polymer has poor compatibility with other components of the photopolymer composition and thus, phase separation occurs between the components, thereby allowing the holographic recording medium formed from the photopolymer composition to exhibit excellent optical recording characteristics and excellent durability under high temperature/high humidity conditions.

The number average molecular weight means a number average molecular weight (unit: g/mol) converted in terms of polystyrene determined by GPC method. In the process of determining the number average molecular weight in terms of polystyrene measured by the GPC method, a commonly known analyzing device, a detector such as a refractive index detector, and an analytical column can be used, and commonly applied conditions for temperature, solvent, and flow rate can be used. Specific examples of the measurement conditions may include a temperature of 30° C., tetrahydrofuran solvent and a flow rate of 1 mL/min.

The (meth)acrylic-based polyol may mean a polymer in which one or more, specifically two or more, hydroxy groups are bonded to the main chain or side chain of a (meth)acrylate-based polymer. Unless specifically stated otherwise, “(meth)acrylic (based)” as used herein refers to acrylic (based) and/or methacrylic (based), which is a term that encompasses all of acrylic (based), methacrylic (based), or a mixture of acrylic (based) and methacrylic (based).

The (meth)acrylic-based polyol is a homopolymer of a (meth)acrylate-based monomer having a hydroxy group, or a copolymer of two or more types of (meth)acrylate-based monomers having a hydroxy group, or a copolymer of a (meth)acrylate-based monomer having a hydroxy group and a (meth)acrylate-based monomer having no hydroxy group. As used herein. “copolymer” is a term that encompasses random all of a copolymer, a block copolymer and a graft copolymer, unless otherwise specified.

The (meth)acrylate-based monomer having a hydroxy group may include, for example, hydroxyalkyl (meth)acrylate, hydroxyaryl (meth)acrylate, or the like, the alkyl is an alkyl having 1 to 30 carbon atoms, and the aryl may be an aryl having 6 to 30 carbon atoms. Further, the (meth)acrylate-based monomer having no hydroxy group may include, for example, an alkyl (meth)acrylate-based monomer, an aryl (meth)acrylate-based monomer, or the like, the alkyl may be an alkyl having 1 to 30 carbon atoms, and the aryl may be an aryl having 6 to 30 carbon atoms.

The (meth)acrylic-based polyol may have a weight average molecular weight (Mw) in the range of 150,000 to 1,000,000 as an example. The weight average molecular weight means a weight average molecular weight converted in terms of polystyrene measured by the GPC method as described above. For example, the lower limit of the weight average molecular weight may be 150,000 or more, 200,000 or more, or 250,000 or more, and the upper limit thereof may be, for example, 900,000 or less, 850,000 or less, 800,000 or less, 750,000 or less, 700,000 or less, 650,000 or less, 600,000 or less, 550,000 or less, 500,000 or 450,000 or less. When the weight average molecular weight of the (meth)acrylic-based polyol satisfies the above range, the polymer matrix sufficiently exerts the function as a support and thus, the recording properties for optical information less decrease even after the usage time has passed, and sufficient flexibility is imparted to the polymer matrix, thereby being able to improve the mobility of components (e.g., photoreactive monomer or plasticizer, etc.) contained in the photopolymer composition, and minimize the decrease in recording characteristics for optical information.

In order to adjust the crosslinking density of the (meth)acrylic-based polyol by the siloxane-based polymer at a level that is advantageous for ensuring the function of the holographic recording medium, the hydroxyl equivalent of the (meth)acrylic-based polyol may be adjusted to an appropriate level.

Specifically, the hydroxyl (—OH) equivalent of the (meth)acrylic-based polyol may be, for example, in the range of 500 to 3,000 g/equivalent. More specifically, the lower limit of the hydroxyl group (—OH) equivalent of the (meth)acrylic-based polyol may be 600 g/equivalent or more, 700 g/equivalent or more, 800 g/equivalent or more, 900 g/equivalent or more, 1000 g/equivalent or more, 1100 g/equivalent or more, 1200 g/equivalent or more, 1300 g/equivalent or more, 1400 g/equivalent or more, 1500 g/equivalent or more, 1600 g/equivalent or more, 1700 g/equivalent or more, or 1750 g/equivalent or more. And, the upper limit of the hydroxyl group (—OH) equivalent of the (meth)acrylic-based polyol may be 2900 g/equivalent or less, 2800 g/equivalent or less, 2700 g/equivalent or less, 2600 g/equivalent or less, 2500 g/equivalent or less, 2400 g/equivalent or less, 2300 g/equivalent or less, 2200 g/equivalent or less, 2100 g/equivalent or less, 2000 g/equivalent or less, or 1900 g/equivalent or less. The hydroxyl (—OH) equivalent of the (meth)acrylic-based polyol is the equivalent (g/equivalent) of one hydroxy functional group, which is the value obtained by dividing the weight average molecular weight of the (meth)acrylic-based polyol by the number of hydroxy functional groups per molecule. As the equivalent value is smaller, the functional group density is higher, and as the equivalent value is larger, the functional group density is smaller. When the hydroxyl (—OH) equivalent of the (meth)acrylic-based polyol satisfies the above range, the polymer matrix has an appropriate crosslinking density and thus, sufficiently performs the role of a support, and the mobility of the components included in the photopolymer layer is improved, which allows the initial refractive index modulation value to be maintained at an excellent level even as time passes without the problem of collapsing the boundary surfaces of the diffraction gratings generated after recording, thereby minimizing the decrease in recording characteristics for optical information.

For example, the (meth)acrylic-based polyol may have a glass transition temperature (Tg) in the range of −60 to −10° C. Specifically, the lower limit of the glass transition temperature may be, for example, −55° C. or more, −50° C. or more, −45° C. or more, −40° C. or more, −35° C. or more, −30° C. or more, or −25° C. or more, and the upper limit thereof may be, for example, −15° C. or less, −20° C. or less, −25° C. or less, −30° C. or less, or −35° C. or less. If the above glass transition temperature range is satisfied, it is possible to lower the glass transition temperature without significantly reducing the modulus of the polymer matrix, thereby increasing the mobility (fluidity) of other components in the photopolymer composition, and also improving the moldability of the photopolymer composition. The glass transition temperature can be measured using a known method, for example, DSC (Differential Scanning calorimetry) or DMA (dynamic mechanical analysis).

The refractive index of the (meth)acrylic-based polyol may be, for example, 1.40 or more and less than 1.50. Specifically, the lower limit of the refractive index of the (meth)acrylic-based polyol may be, for example, 1.41 or more, 1.42 or more, 1.43 or more, 1.44 or more, 1.45 or more, or 1.46 or more, and the upper limit thereof may be, for example, 1.49 or less, 1.48 or less, 1.47 or less, 1.46 or less, or 1.45 or less. When the (meth)acrylic-based polyol has a refractive index within the above-mentioned range, it can contribute to increasing the refractive index modulation. The refractive index of the (meth)acrylic-based polyol is a theoretical refractive index, and can be calculated using the refractive index (value measured using an Abbe refractometer at 25° C.) of the monomer used for preparing the (meth)acrylic-based polyol and the fraction (molar ratio) of each monomer.

The (meth)acrylic-based polyol and siloxane-based polymer may be used so that the molar ratio (SiH/OH) of the silane functional group (Si—H) of the siloxane-based polymer to the hydroxyl group (—OH) of the (meth)acrylic-based polyol is 0.80 to 1.20. That is, the type and content of the siloxane-based polymer and the (meth)acrylic-based polyol can be selected so as to satisfy the molar ratio when forming the polymer matrix. The lower limit of the molar ratio (SiH/OH) may be, for example, 0.81 or more, 0.85 or more, 0.90 or more, 0.95 or more, 1.00 or more, or 1.05 or more, and the upper limit thereof may be, for example, 1.19 or less, 1.15 or less, 1.10 or less, 1.05 or less, 1.00 or less, or 0.95 or less. When satisfying the above molar ratio (SiH/OH) range, the polymer matrix is crosslinked at an appropriate crosslinking density, so that reliability under high temperature/high humidity conditions is improved, and a sufficient refractive index modulation value can be realized.

The Pt-based catalyst may be, for example, Karstedt's catalyst, and the like. The precursor of the polymer matrix may optionally further include rhodium-based catalysts, iridium-based catalysts, rhenium-based catalysts, molybdenum-based catalysts, iron-based catalysts, nickel-based catalysts, alkali metal or alkaline earth metal-based catalysts, Lewis acids-based or carbene-based non-metallic catalysts, in addition to the Pt-based catalyst.

The photoreactive monomer comprises a monofunctional monomer and a polyfunctional monomer.

Specifically, the photoreactive monomer may include a polyfunctional (meth)acrylate monomer and a monofunctional (meth)acrylate monomer.

Further, in the photopolymer composition, the ratio of the monofunctional monomer among the photoreactive monomers is more than 40% by weight to 70% by weight, 42 to 68% by weight, or 45 to 65% by weight. Therefore, based on the total 100 of the photoreactive monomers, the remaining content may include a polyfunctional monomer.

As mentioned above, in a portion where the monomer is polymerized in the process of photopolymerization of the photopolymer composition and the polymer is present in relatively large amounts, the refractive index becomes high. In a portion where the polymer binder is present in relatively large amount, the refractive index becomes relatively low, the refractive index modulation occurs, and a diffraction grating is generated by such refractive index modulation.

Specifically, an example of the polyfunctional monomer can include (meth)acrylate-based α,β-unsaturated carboxylic acid derivatives, for example, (meth)acrylate, (meth)acrylamide, (meth)acrylonitrile, (meth)acrylic acid or the like, or a compound containing a vinyl group or a thiol group.

An example of the polyfunctional monomer can include a polyfunctional (meth)acrylate monomer having a refractive index of 1.5 or more, 1.53 or more, or 1.5 to 1.7. The polyfunctional (meth)acrylate monomer having a refractive index of 1.5 or more, or 1.53 or more, or 1.5 to 1.7 can include a halogen atom (bromine, iodine, etc.), sulfur(S), phosphorus (P), or an aromatic ring.

More specific examples of the polyfunctional (meth)acrylate monomer having a refractive index of 1.5 or more include bisphenol A modified diacrylate type, fluorene acrylate series (HR6022, etc. manufactured by Miwon Specialty Chemical Co., Ltd.), bisphenol fluorene epoxy acrylate series (HR6100, HR6060, HR6042, etc. manufactured by Miwon Specialty Chemical Co., Ltd.), halogenated epoxy acrylate series (HR1139, HR3362, etc. manufactured by Miwon Specialty Chemical Co., Ltd.).

An example of the monofunctional monomer can include a monofunctional (meth)acrylate monomer. The monofunctional (meth)acrylate monomer can contain an ether bond and a fluorene functional group in the molecule. Specific examples of such monofunctional (meth)acrylate monomer include 2-phenylphenoxyethyl acrylate, phenoxybenzyl (meth)acrylate, o-phenylphenol ethylene oxide (meth)acrylate, benzyl (meth)acrylate, 2-(phenylthio)ethyl (meth)acrylate, biphenylmethyl (meth)acrylate, or the like.

At this time, the polyfunctional monomer may include a monofunctional monomer. For example, HR6042 may be a 40% monofunctional acrylate containing product, and thus, the polyfunctional:monofunctional ratio may be 6:4.

On the other hand, the photoreactive monomer can have a weight average molecular weight of 50 g/mol to 1000 g/mol, or 200 g/mol to 600 g/mol. The weight average molecular weight refers to a weight average molecular weight converted in terms of polystyrene measured by a GPC method.

The photopolymer composition of one embodiment may contain a photoreactive monomer in an amount of 20 to 300 parts by weight based on 100 parts by weight of the polymer matrix or the precursor thereof. For example, the lower limit of the content of the photoreactive monomer may be 20 parts by weight or more, 40 parts by weight or more, 50 parts by weight or more, or 70 parts by weight or more, and the upper limit thereof may be 300 parts by weight or less, 200 parts by weight or less, 150 parts by weight or less, or 100 parts by weight or less. At this time, the content of the polymer matrix that serves as a reference means the content (weight) of the (meth)acrylic-based polyol and siloxane-based polymer forming the matrix. When the above range is satisfied, it is advantageous to ensure excellent optical recording characteristics and durability in a high temperature/high humidity environment.

The photopolymer composition includes a photoinitiator. The photoinitiator is a compound which is activated by light or actinic radiation and initiates polymerization of a compound containing a photoreactive functional group such as the photoreactive monomer.

As the photoinitiator, commonly known photoinitiators can be used without particular limitation, but specific examples thereof include a photoradical polymerization initiator, a photocationic polymerization initiator, or a photoanionic polymerization initiator.

Specific examples of the photoradical polymerization initiator include imidazole derivatives, bisimidazole derivatives, N-aryl glycine derivatives, organic azide compounds, titanocene, aluminate complex, organic peroxide, N-alkoxypyridinium salts, thioxanthone derivatives, amine derivatives or the like. More specifically, examples of the photoradical polymerization initiator include 1,3-di(t-butyldioxycarbonyl)benzophenone, 3,3′,4,4″-tetrakis(t-butyldioxycarbonyl)benzophenone, 3-phenyl-5-isoxazolone, 2-mercapto benzimidazole, bis(2,4,5-triphenyl)imidazole, 2,2-dimethoxy-1,2-diphenylethane-1-one (product name: Irgacure 651/manufacturer: BASF), 1-hydroxy-cyclohexyl-phenyl-ketone (product name: Irgacure 184/manufacturer: BASF), 2-benzyl-2-dimethylamino-1-(4-morpholinophenyl)-butanone-1 (product name: Irgacure 369/manufacturer: BASF), and bis(η5-2,4-cyclopentadiene-1-yl)-bis(2,6-difluoro-3-(1H-pyrrole-1-yl)-phenyl) titanium (product name: Irgacure 784/manufacturer: BASF), Ebecryl P-115 (manufacturer: SK entis), or the like.

The photocationic polymerization initiator may include a diazonium salt, a sulfonium salt, or an iodonium salt, and examples thereof include sulfonic acid esters, imidosulfonates, dialkyl-4-hydroxysulfonium salts, arylsulfonic acid-p-nitrobenzyl esters, silanol-aluminum complexes, (η6-benzene) (η5-cyclopentadienyl) iron (II), or the like. In addition, benzoin tosylate, 2,5-dinitrobenzyltosylate, N-tosylphthalic acid imide, or the like can be mentioned. More specific examples of the photocationic polymerization initiator include commercially available products such as Cyracure UVI-6970, Cyracure UVI-6974 and Cyracure UVI-6990 (manufacturer: Dow Chemical Co. in USA), Irgacure 264 and Irgacure 250 (manufacturer: BASF) or CIT-1682 (manufacturer: Nippon Soda).

The photoanionic polymerization initiator may be borate salt, for example, butyryl chlorine butyl triphenyl borate, or the like. More specific examples of the photoanionic polymerization initiator include commercially available products such as Borate V (manufacturer: Spectra Group).

In addition, the photopolymer composition of the embodiment may include monomolecular (type I) initiator or bimolecular (type II) initiator. The (type I) system for free radical photopolymerization may include, for example, an aromatic ketone compounds in combination with a tertiary amine, such as benzophenone, alkylbenzophenone, 4,4′-bis(dimethylamino)benzophenone (Michler's ketone), anthrone and halogenated benzophenone or a mixture of these types. The bimolecular (type II) initiator may include benzoin and derivatives thereof, benzyl ketal, acylphosphine oxide, for example, 2,4,6-trimethylbenzoyldiphenylphosphine oxide, bisacylophosphine oxide, phenylglyoxyl ester, camphorquinone, alpha-aminoalkylphenone, alpha,alpha-dialkoxyacetophenone, 1-[4-(phenylthio) phenyl]octane-1,2-dione 2-(O-benzoyloxime), alpha-hydroxyalkylphenone, and the like.

The photopolymer composition may include an initiator in the range of 0.1 to 10.0 parts by weight based on 100 parts by weight of the polymer matrix component. Specifically, the lower limit of the content of the initiator may be, for example, 0.2 parts by weight or more, 0.3 parts by weight or more, 0.4 parts by weight or more, 0.5 parts by weight or more, 0.6 parts by weight or more, 0.7 parts by weight or more, 0.8 parts by weight or more, or 0.9 parts by weight or more. And the upper limit thereof may be, for example, 5.0 parts by weight or less. When the above range is satisfied, it is advantageous for ensuring optical recording characteristics and durability at high temperature/high humidity.

On the other hand, the photopolymer composition for hologram formation may further include a non-reactive fluorinated compound. Specific details of the non-reactive fluorinated compound are as described above.

On the other hand, the adhesive additive may include a polydimethylsiloxane-based additive. Regarding the polydimethylsiloxane-based additive, all the above-mentioned contents are included.

As mentioned above, the ratio of the monofunctional monomer among the photoreactive monomers may be more than 40% by weight and 70% by weight or less, 42 to 68% by weight, or 45 to 65% by weight, wherein in addition to products containing both a monofunctional monomer and a polyfunctional monomer, the monofunctional acrylate-based monomer can be further used to adjust the above-mentioned weight ratio.

The further used monofunctional acrylate-based monomer can also serve as an adhesive additive to improve adhesion, and when used in combination with a polydimethylsiloxane-based additive, the adhesion-enhancing effect and optical performance can be further improved.

The further used adhesive additive may be the same as the monofunctional monomer. Thus, the acrylate-based monomer may include 2-phenylphenoxyethyl acrylate, phenoxy benzyl (meth)acrylate, o-phenylphenol ethylene oxide (meth)acrylate, benzyl (meth)acrylate, 2-(phenylthio) ethyl (meth)acrylate, biphenylmethyl (meth)acrylate, or the like.

In addition, the photopolymer composition may further include at least one selected from the group consisting of a dye, a catalyst, an antifoaming agent, and a plasticizer.

Specifically, the photopolymer composition may further include a photosensitizing dye. The photosensitizing dye serves as a photosensitizing pigment to sensitize the photoinitiator. More specifically, the photosensitizing dye can be stimulated by the light irradiated on the photopolymer composition and can also serve as an initiator to initiate polymerization of the monomer and the cross-linking monomer. The photopolymer composition can contain 0.01% by weight to 30% by weight, or 0.05% by weight to 20% by weight of the photosensitizing dye.

Examples of the photosensitizing dye are not particularly limited, and various compounds commonly known in the art can be used. Specific examples of the photosensitizing dye include sulfonium derivative of ceramidonine, new methylene blue, thioerythrosine triethylammonium, 6-acetylamino-2-methylceramidonin, eosin, erythrosine, rose bengal, thionine, basic yellow, Pinacyanol chloride, Rhodamine 6G, Gallocyanine, ethyl violet, Victoria blue R, Celestine blue, QuinaldineRed, Crystal Violet, Brilliant Green, Astrazon orange G, Darrow Red, Pyronin Y, Basic Red 29, pyrylium iodide, Safranin O, Cyanine, Methylene Blue, Azure A, or a combination of two or more thereof.

The photopolymer composition can include a catalyst which is commonly known for promoting polymerization of the polymer matrix or the photoreactive monomer. Examples of the catalyst include platinum-based catalysts such as Karstedt's catalyst, rhodium-based catalysts, iridium-based catalysts, rhenium-based catalysts, molybdenum-based catalysts, iron-based catalysts, nickel-based catalysts, alkali metal and alkaline earth metal catalysts. As the non-metal catalyst, a Lewis acids-based catalyst, a carbene-based catalyst, or the like can be used.

The photopolymer composition can further include other additives.

Examples of the other additives include a defoaming agent or a phosphate-based plasticizer, and the defoaming agent can be a silicone-based reactive additive, for example, Tego Rad 2500. Examples of the plasticizer include phosphate compounds such as tributyl phosphate, and the plasticizer can be added in a weight ratio of 1:5 to 5:1 together with the fluorinated compound. The plasticizer can have a refractive index of less than 1.5 and a molecular weight of 700 or less.

The photopolymer composition can include an organic solvent. Non-limiting examples of the organic solvent include ketones, alcohols, acetates, ethers, and a mixture of two or more thereof.

Specific examples of the organic solvent include ketones such as methyl ethyl ketone, methyl isobutyl ketone, acetylacetone or isobutyl ketone; alcohols such as methanol, ethanol, n-propanol, i-propanol, n-butanol, i-butanol or t-butanol; acetates such as ethyl acetate, i-propyl acetate, or polyethylene glycol monomethyl ether acetate; ethers such as tetrahydrofuran or propylene glycol monomethyl ether; or a mixture of two or more thereof.

The organic solvent can be added at the time of mixing the respective components contained in the photopolymer composition, or can be contained in the photopolymer composition by adding the respective components dispersed or mixed in an organic solvent. When the content of the organic solvent in the photopolymer composition is too low, flowability of the photopolymer composition may be lowered, resulting in the occurrence of defects such as striped patterns on the finally produced film. In addition, when too much organic solvent is added, the solid content is lowered, and coating and film formation are not sufficient, so that physical properties and surface characteristics of the film may be deteriorated and defects may occur during the drying and curing process. Thus, the photopolymer composition can include an organic solvent such that the total solid content concentration of the components contained is 1% by weight to 70% by weight, or 2% by weight to 50% by weight.

Specifically, the photopolymer composition may include a solvent so that the concentration of the total solid content of the components contained in the composition is 1 to 70% by weight. Specifically, the photopolymer composition may include a solvent so that the concentration of the total solid content of the components contained in the composition is 2% by weight or more, 5% by weight or more, 10% by weight or more, or 20% by weight or more, and 65% by weight or less, 60% by weight or less, 55% by weight or less, or 50% by weight or less. When the content of the solvent in the composition is too low, flowability of the composition may be lowered, resulting in the occurrence of defects such as striped patterns on the finally produced film. In addition, when too much organic solvent is added, the solid content is lowered, and coating and film formation are not sufficient, so that physical properties and surface characteristics of the photopolymer film may be deteriorated and defects may occur during the drying and curing process

The photopolymer composition can be used for holographic recording.

Further, according to one embodiment of the invention, through the process of mixing and curing the photopolymer composition, it is possible to produce a holographic recording medium including a photopolymer layer in a state in which in which no visual hologram is recorded, and a visual hologram can be recorded on the medium through a predetermined exposure process.

A visual hologram can be recorded on the media provided through the process of mixing and curing the photopolymer composition, using known devices and methods under commonly known conditions.

In one example, a method for preparing a holographic recording medium may include the steps of: applying the photopolymer composition on a substrate to form a photopolymer film; and irradiating a coherent laser onto a predetermined region of the photopolymer film and selectively polymerizing a monofunctional monomer and a polyfunctional monomer contained in the photopolymer film to record optical information.

The photopolymer composition may be the photopolymer composition of one embodiment described above, and the photopolymer composition has been described in detail above, and therefore, a detailed description thereof is omitted here.

In the step of forming the photopolymer film, a photopolymer composition containing the above-mentioned configuration can first be prepared. When preparing the photopolymer composition, for mixing the respective components contained therein, a mixing device, a stirrer, a mixer, or the like which are commonly known in the art can be used without particular limitation. Further, such a mixing process may be performed at a temperature ranging from 0° C. to 100° C., a temperature ranging from 10° C. to 80° C., or a temperature ranging from 20° C. to 60° C.

In the step of forming the photopolymer film, the prepared photopolymer composition can be applied onto the substrate to form a coating film formed from the photopolymer composition. The coating film can be dried naturally at room temperature or dried at a temperature in the range of 30 to 80° C. This process can induce a hydrosilylation reaction between the hydroxy group of the (meth)acrylic-based polyol remaining unreacted and the silane functional group of the siloxane-based polymer.

On the other hand, according to another embodiment of the invention, an optical element including the holographic recording medium can be provided.

Specific examples of the optical element include optical lenses, mirrors, deflecting mirrors, filters, diffusing screens, diffraction elements, light guides, waveguides, holographic optical elements having projection screen and/or mask functions, medium of optical memory system and light diffusion plate, optical wavelength multiplexers, reflection type, transmission type color filters, and the like.

An example of the optical element including the holographic recording medium may include a hologram display device.

The hologram display device includes a light source unit, an input unit, an optical system, and a display unit. The light source unit is a part that irradiates a laser beam used for providing, recording, and reproducing three-dimensional image information of an object in the input unit and the display unit. Further, the input unit is a part that previously inputs three-dimensional image information of an object to be recorded on the display unit, and for example, three-dimensional information of an object such as the intensity and phase of light for each space can be input into an electrically addressed liquid crystal SLM, wherein an input beam may be used. The optical system may include a mirror, a polarizer, a beam splitter, a beam shutter, a lens, and the like. The optical system can be distributed into an input beam for sending a laser beam emitted from the light source unit to the input unit, a recording beam for sending the laser beam to the display unit, a reference beam, an erasing beam, a reading beam, and the like.

The display unit can receive three-dimensional image information of an object from an input unit, record it on a hologram plate comprising an optically addressed SLM, and reproduce the three-dimensional image of the object. At this time, the three-dimensional image information of the object can be recorded via interference of the input beam and the reference beam. The three-dimensional image information of the object recorded on the hologram plate can be reproduced into a three-dimensional image by the diffraction pattern generated by the reading beam. The erasing beam can be used to quickly remove the formed diffraction pattern. On the other hand, the hologram plate can be moved between a position at which a three-dimensional image is inputted and a position at which a three-dimensional image is reproduced.

### Advantageous Effects

According to the present invention, a holographic recording medium having a photopolymer layer that not only has excellent recording efficiency but also realizes a higher refractive index modulation value even in a thin thickness range, has improved adhesion between adhesive protective layers, and has low haze characteristics, and is more excellent in reliability than in the conventional one can be provided.

Further, according to the present invention, a holographic recording medium and an optical element that realize a higher refractive index modulation value even in a thin thickness range and has low haze characteristics and excellent adhesion characteristics can be provided.

### BRIEF DESCRIPTION OF THE DRAWINGS

FIG. 1 briefly shows the structure of a holographic recording medium according to an embodiment.

### DETAILED DESCRIPTION OF THE EMBODIMENTS

Hereinafter, the action and effect of the invention will be described in more detail with reference to specific examples of the invention. However, these examples are presented for illustrative purposes only, and the scope of the invention is not limited thereby in any way.

### PREPARATION EXAMPLE

### Preparation Example 1: Preparation of (Meth)acrylic-Based Polyol

132 g of butyl acrylate, 420 g of ethyl acrylate, and 48 g of hydroxybutyl acrylate were added to a 2 L jacketed reactor, and diluted with 1200 g of ethyl acetate. The reaction temperature was set to 60-70° C., and the mixture was stirred for about 30 minutes to 1 hour. 0.42 g of n-dodecyl mercaptan (n-DDM) was further added, and stirring was further performed for about 30 minutes. Then, 0.24 g of AIBN as a polymerization initiator was added, polymerization was carried out at the reaction temperature for 4 hours or more, and kept until the residual acrylate content became less than 1%. Thereby, a (meth)acrylate-based copolymer (weight average molecular weight of about 300,000, OH equivalent of about 1802 g/equivalent) in which the hydroxy group was located in the branched chain was prepared.

### Preparation Example 2: Preparation of Fluorinated Compound

20.51 g of 2,2′-{oxybis[(1,1,2,2-tetrafluoroethane-2,1-diyl)oxy]}bis(2,2-difluoroethan-1-ol) was added to a 1000 mL flask, then dissolved in 500 g of tetrahydrofuran, and 4.40 g of sodium hydride (60% dispersion in mineral oil) was carefully added several times while stirring at 0° C. After stirring at 0° C. for 20 minutes, 12.50 mL of 2-methoxyethoxymethyl chloride was slowly dropped. When it was confirmed by 1H NMR that all of the reactants were consumed, work-up using dichloromethane gave 29 g of a liquid product with a purity of 95% or more in a yield of 98%. The weight average molecular weight of the prepared fluorinated compound was 586, and the refractive index measured with an Abbe refractometer was 1.361.

### EXAMPLE AND COMPARATIVE EXAMPLE: PREPARATION OF PHOTOPOLYMER COMPOSITION AND HOLOGRAPHIC MEDIUM

### Example 1: Preparation of Photopolymer Composition and Holographic Recording Medium

### (1) Preparation of Photopolymer Composition (Prepared Under Dark Room Conditions)

0.48 g of trimethylsilyl terminated poly(methylhydrosiloxane) (prepared by Sigma-Aldrich, number average molecular weight: about 390) as a siloxane polymer and 28.0 g (30 wt. %) of (meth)acrylic-based polyol prepared in Preparation Example 1 were first mixed to prepare a mixed solution (SiH/OH molar ratio=1.0).

Then, as shown in Table 1, the photopolymer composition was prepared so that the ratio of the monofunctional monomer among the photoreactive monomers was about 46 wt. %. That is, 14.5 g of a polyfunctional monomer (HR6042 (polyfunctional:monofunctional=6:4); Miwon Specialty Chemical, refractive index: 1.6) as the photoreactive monomer, 1.6 g of a monofunctional monomer (2-phenylphenoxyethyl acrylate), and 0.11 g of BYK 331 (Byk Gardner, Wesel, Germany) as an adhesive additive were added and mixed thoroughly.

Then, 0.21 g of Borate V as a coinitiator, 0.05 g of H-Nu 254, 0.08 g of photosensitizing dye H-Nu 640, 9.1 g of the fluorinated compound of Preparation Example 2 and methyl ethyl ketone, methanol, EA, and methyl isobutyl ketone (MIBK) as solvents were added in a ratio of 3:2:4:4 to the mixture, and then the mixture was thoroughly mixed again with a paste mixer while blocking light for about 10 minutes.

Then, for matrix crosslinking, 0.25 g (2 wt. %) of Karstedt (Pt-based) catalyst was added and mixed thoroughly at room temperature for 30 minutes or more, and then subjected to liquid crosslinking to prepare a photopolymer composition (photopolymerizable composition).

### (2) Preparation of Holographic Recording Media

The photopolymer composition was applied at 1.2 m/min onto a 40 μm thick TAC substrate with a wet film thickness of 15 μm using a Meyer bar and coated to a thickness of 15 μm, and dried at 80° C. for 10 minutes to form a non-adhesive photopolymer layer with a thickness of about 15 μm. After drying, the photopolymer coating thickness was about 15 μm, and the refractive index (n) of the photopolymer was about 1.501. Then, the sample was left in a dark room under constant temperature and humidity conditions of about 25° C. and relative humidity of 50RH % for 24 hours or more.

The photopolymer layer prepared in this way was incorporated by a red hologram exposure using a slanted recording method.

Then, a BPSA adhesive protective layer 4 of the same size was laminated to a thickness of 25 μm on a slide glass 5 with a thickness of 0.70 mm and a size of 10×10 cm to prepare a photopolymer film. Then, in order to serve as an indicator during peeling, a 60 μm mold release films (MRF) 3 was laminated at a predetermined interval so as to intersect by about 0.5 to 1 cm at the end of the adhesive protective layer.

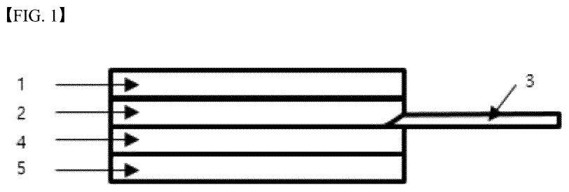

Subsequently, the mold release film was primarily laminated to a thickness of 25 mm so that the photopolymer layer 2 was abutted on the adhesive protective layer intersected and formed at the end of the adhesive protective layer, and then secondarily laminated to a thickness of 25 mm so that the photopolymer layer 1 was abutted thereon again, thereby preparing a final holographic recording medium (photopolymer film) having the structure shown in FIG. 1 (width 25 mm, length 80 mm, thickness 55 μm).

### Examples 2 to 6 and Comparative Examples 1 to 3: Preparation of Photopolymer Composition and Holographic Recording Medium

A photopolymer composition and a holographic recording medium were prepared in the same manner as in Example 1, except that the addition components were changed as shown in Table 1 below.

TABLE 1

| | | | | Ratio of monofunctional |
|---|---|---|---|---|
| | | | Monofunctional | acrylate monomers |
| | Photopolymerizable | | acrylate-based | among |
| | monomer | Adhesive | monomer | photopolymerizable |
| | (recording monomer) | additive | (addition) | monomers (wt. %) |
| Example 1 | HR6042 14.5 g | BYK 331 | 2-phenylphenoxyethyl | about 46 wt. % |
| | | 0.11 g | acrylate, 1.6 g | |
| Example 2 | HR6042 12.9 g | BYK 331 | 2-phenylphenoxyethyl | about 52 wt. % |
| | | 0.11 g | acrylate, 3.2 g | |
| Example 3 | HR6042 11.3 g | BYK 331 | 2-phenylphenoxyethyl | about 58 wt. % |
| | | 0.11 g | acrylate, 4.8 g | |
| Example 4 | HR6042 9.7 g | BYK 331 | 2-phenylphenoxyethyl | about 64 wt. % |
| | | 0.11 g | acrylate, 6.4 g | |
| Example 5 | HR6042 14.5 g | BYK 3565 | 2-phenylphenoxyethyl | about 46 wt. % |
| | | 0.11 g | acrylate, 1.6 g | |
| Example 6 | HR6042 12.9 g | BYK 3565 | 2-phenylphenoxyethyl | about 52 wt. % |
| | | 0.11 g | acrylate, 3.2 g | |
| Compare | HR6042 16.1 | 0 | 0 | 40 wt. % |
| Example 1 | | | | |
| Compare | HR6042 16.1 | BYK 3550 | 0 | 40 wt. % |
| Example 2 | | 0.11 g | | |
| Compare | HR6042 16.1 | BYK 310 | 0 | 40 wt. % |
| Example 3 | | 0.11 g | | |

* HR6042 (containing polyfunctional acrylate-based monomer: monofunctional acrylate-based monomer in a weight ratio of 6:4)

### EXPERIMENTAL EXAMPLE: HOLOGRAPHIC RECORDING (EVALUATION OF PHYSICAL PROPERTIES AND PERFORMANCE OF HOLOGRAPHIC RECORDING MEDIA)

The physical properties of Examples and Comparative Examples were measured by the following method, and the results are shown in Table 2 below.

### (1) Evaluation of Adhesion

In the holographic recording medium sample, the mold release film 3 and the adhesive protective layer 4 were peeled off, and the adhesive force between the photopolymer layer 2 and the adhesive protective layer 4 was measured with an adhesive force measuring device, and the results were shown in Table 2 below. A 180° Peel Test was performed using a Texture Analyzer as the adhesive force measuring device, the load applied to a width of 25 mm was measured to evaluate the adhesion.

### (2) Measurement of Water Contact Angle

Regarding the above holographic recording medium sample, 2 μl of H₂O was dropped onto the photopolymer layer exposed to a 660 nm red light source (light intensity: 3.0 mJ), and then the water contact angle (surface contact angle) of the photopolymer layer was measured using a drop shape analyzer.

### (3) Measurement of Diffractive Efficiency (DE) (Unit %)

Regarding the holographic recording medium sample using the photopolymer composition, the reflection spectrum of the recorded photopolymer was measured using a UV-VIS spectrophotometer (SolidSpec-3700, manufactured by Shimadzu), the reflection peak was confirmed, and the diffraction efficiency was measured.

Specifically, the photopolymer coated surfaces prepared in each of Examples and Comparative Examples were laminated onto a glass slide, and fixed so that the laser first passed through the glass surface during recording.

Holographic recording was performed through the interference of two coherent lights (reference light and object light), and in transmission type recording, both beams were made incident on the same plane of the sample. The diffraction efficiency changes depending on the incidence angle of the two beams, and if both beams have the same incidence angle, they are non-slanted. In the non-slanted recording, the incident angles of both beams were equal with respect to the normal, so the diffraction grating was generated perpendicular to the film.

Recording was performed in a transmission-type non-slanted method (2θ=45°) using a laser with a wavelength of 532 nm, and the diffraction efficiency (η) was calculated according to the following Equation 2.

$$η ( \% ) = \{ {P}_{D} / ( {P}_{D} + {P}_{T} ) \} \times 100 \qquad [ Equation 2 ]$$

wherein, in Equation 2, η is the diffraction efficiency, P_{D} is the output amount (mW/cm²) of the diffracted beam of the sample after recording, and P_{T} is the output amount (mW/cm²) of the transmitted beam of the sample after recording.

### (4) Measurement of Refractive Index Modulation Value (Δn)

In Lossless Dielectric grafting of a transmission-type hologram, the refractive index modulation value Δn can be calculated from the following Equation 2.

$$η ( DE ) = {sin}^{2} ( \sqrt{{v}^{2}} ) = {sin}^{2} ( \frac{πΔ nd}{λ cos θ} ) \qquad [ Equation 2 ]$$

wherein, in Equation 2, d is the thickness of the photopolymer layer, Δn is the refractive index modulation value, η(DE) is the diffraction efficiency, and λ is the recording wavelength.

### (5) Haze

Haze was measured at the recording portion of the recorded photopolymer using a HAZE METER (NDH-5000 manufactured by Nippon Denshoku Kogyo Co., Ltd.) in accordance with JIS K7136:2000. The measurement light was made incident on the substrate side of the hologram recording medium.

TABLE 2

| | Example | Example | Example | Example | Example | Example | Comparative | Comparative | Comparative |
|---|---|---|---|---|---|---|---|---|---|
| Category | 1 | 2 | 3 | 4 | 5 | 6 | Example 1 | Example 2 | Example 3 |
| Adhesive force | 1200 | 1300 | 1400 | 1400 | 600 | 650 | 600 | 15 | 16 |
| between | | | | | | | | | |
| photopolymer | | | | | | | | | |
| layer 2 and | | | | | | | | | |
| adhesive | | | | | | | | | |
| protective layer 4 | | | | | | | | | |
| (gf/20 mm) | | | | | | | | | |
| Water contact | 68 | 66 | 66 | 65 | 74 | 74 | 80 | 85 | 84 |
| angle after light | | | | | | | | | |
| irradiation (°) | | | | | | | | | |
| Diffraction | 38 | 37 | 35 | 31 | 35 | 32 | 32 | 38 | 39 |
| efficiency DE | | | | | | | | | |
| (%) | | | | | | | | | |
| Δn | 0.024 | 0.023 | 0.022 | 0.020 | 0.025 | 0.020 | 0.022 | 0.023 | 0.024 |
| Haze (%) | 1.9 | 1.9 | 2.0 | 2.0 | 1.9 | 1.9 | 4.8 | 2.0 | 2.3 |

Referring to Table 2, it was confirmed that the holographic recording medium prepared from the photopolymer composition of Examples according to one embodiment of the invention includes a specific adhesive additive in the photopolymer composition, it is excellent in adhesive force and has a refractive index modulation value (Δn) of 0.020 or more, and at the same time, has excellent diffraction efficiency and low haze value.

On the other hand, it was confirmed that the surface of the holographic recording medium provided from the composition of Comparative Example 1 is excessively sticky, and that it has a relatively high haze value. That is, the holographic recording medium provided in Comparative Example 1 has the problem that not only it has low transparency, but also surface components often adhere to other substrate and other parts.

Further, it was confirmed that the holographic recording media provided by the compositions of Comparative Examples 2 and 3 contained different types of additives from those of Examples, and thus the results were poorer than those of Examples in terms of adhesive force.

Therefore, even if Comparative Examples exhibit similar refractive index modulation values and diffraction indices as in Examples, they have higher haze value or poorer adhesive force than in Examples, so that when attaching or detaching the holographic recording medium to the other medium, attachment or detachment is difficult, which may lead to a deterioration of the performance of the holographic recording medium.

1. A holographic recording media comprising a substratesubstrate; an adhesive protective layer; and a photopolymer layer,
wherein an adhesive force between the photopolymer layer and the adhesive protective layer before light irradiation is 500 to 5,000 gf/20 nm, and
wherein a haze value of the photopolymer layer measured in accordance with JIS K7136:2000 is 3% or less.

2. The holographic recording media according to claim 1, wherein:
a water contact angle of the photopolymer layer after the light irradiation is 50 to 100°.

3. The holographic recording media according to claim 1,
further comprising a mold release film between the adhesive protective layer and the photopolymer layer.

4. The holographic recording media according to claim 3, wherein:
the mold release film is laminated so as to intersect between the adhesive protective layer and the photopolymer layer to peel them off.

5. The holographic recording media according to claim 3, wherein:
the mold release film is laminated at predetermined intervals so as to intersect within the range of 0.5 to 1 cm at the end of the adhesive protective layer.

6. The holographic recording media according to claim 1, wherein:
the adhesive protective layer includes at least one selected from the group consisting of an acrylic-based adhesive, a silicone-based adhesive, a urethane-based adhesive and a rubber-based adhesive.

7. The holographic recording media according to claim 1, wherein:
the photopolymer layer includes a photopolymer composition that comprises a polymer matrix or a precursor thereof; a photoreactive monomer including a monofunctional monomer and a polyfunctional monomer; an adhesive additive; and a photoinitiator, and
wherein a ratio of the monofunctional monomer among the photoreactive monomers is more than 40% by weight and 70% by weight or less.

8. The holographic recording media according to claim 7, wherein:
the adhesive additive includes a polydimethylsiloxane-based additive.

9. The holographic recording media according to claim 7, wherein:
the photopolymer composition further includes a non-reactive fluorinated compound.

10. An optical element comprising the holographic recording medium of claim 1.

11. A photopolymer composition for hologram formation comprising a polymer matrix or a precursor thereof; a photoreactive monomer including a monofunctional monomer and a polyfunctional monomer; an adhesive additive; and a photoinitiator,
wherein a ratio of the monofunctional monomer among the photoreactive monomers is more than 40% by weight and 70% by weight or less.

12. The photopolymer composition for hologram formation according to claim 11, wherein:
the adhesive additive includes a polydimethylsiloxane-based additive.

13. The photopolymer composition for hologram formation according to claim 11, wherein:
the photopolymer composition for hologram formation further includes a non-reactive fluorinated compound.
